(19) United States
(12) Patent Application Publication
(10) Pub. No.: US 2008/0079856 A1
(43) Pub. Date: Apr. 3, 2008

(54) LIQUID-CRYSTAL DEVICE, METHOD FOR DRIVING LIQUID-CRYSTAL DEVICE, PROJECTOR, AND ELECTRONIC APPARATUS

(75) Inventors: Kosuke FUKUI, Suwa-shi (JP); Shohei YOSHIDA, Shimosuwa-machi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/854,266

(22) Filed: Sep. 12, 2007

(30) Foreign Application Priority Data
Sep. 26, 2006 (JP) 2006-260732

(51) Int. Cl. G02F 1/1335; C09K 19/02

(52) U.S. Cl. 349/5; 349/168

(57) ABSTRACT

A liquid-crystal device includes first and second substrates opposing each other and a liquid-crystal layer held between the first and second substrates. The liquid-crystal device modulates light by switching the orientation of liquid-crystal molecules in the liquid-crystal layer from a splay state orientation to a bend state orientation. The liquid-crystal device further includes a pixel electrode provided for the first substrate; a first opposing electrode provided for the second substrate, an electric field capable of being generated in the liquid-crystal layer between the pixel electrode and the first opposing electrode; and a second opposing electrode provided for the second substrate, an electric field capable of being generated in the liquid-crystal layer at least between the first opposing electrode and the second opposing electrode.

### BACKGROUND

1. Technical Field

The present invention relates to liquid-crystal devices, methods for driving liquid-crystal devices, projectors, and electronic apparatuses.

2. Related Art

In the field of liquid-crystal devices typified by liquid-crystal televisions and liquid-crystal projectors, improvements in the quality of moving images, not to mention still images, have been required. In order to improve the quality of moving images, liquid-crystal devices are required to have higher response speed. Recently, optical compensated bend (OCB) mode liquid-crystal devices have been attracting considerable attention.

In OCB mode liquid-crystal devices, the orientation of liquid-crystal molecules during an initial state and that during an operating state differ from each other. During the initial state, the liquid-crystal molecules are spread apart widely between two substrates (splay state). During the operating state, the liquid-crystal molecules are arranged so as to form bow shapes between the two substrates (bend state).

When images are displayed or light modulation is performed in the OCB mode liquid-crystal devices, a driving voltage is applied while the liquid-crystal molecules are in the bend state. When the liquid-crystal molecules are in the bend state, the time required for switching the orientation of the liquid-crystal molecules after a voltage is applied is shorter than that in liquid-crystal devices of a twisted nematic (TN) mode or super twisted nematic (STN) mode. Thus, the light transmittance of liquid-crystal layers can be changed in a short time, resulting in high-speed response.

In the OCB mode liquid-crystal device, a voltage higher than or equal to a predetermined threshold level needs to be applied to the liquid-crystal layers so that the orientation of the liquid-crystal molecules is switched from the splay state orientation to the bend state orientation (initial transition). When the initial transition is insufficient, i.e., when the shift from the splay state to the bend state is incomplete, poor display and a reduction in response speed may result. In order to avoid this problem, JP-A-2002-350902, for example, discloses a technology for increasing the speed of splay-to-bend transition by forming wiring lines for facilitating the initial transition between adjacent pixel electrodes. With this, an intense transverse electric field can be generated between the wiring lines and the pixel electrodes so as to facilitate the splay-to-bend transition.

However, the technology disclosed in JP-A-2002-350902 requires wiring lines in addition to those for driving the device, and requires larger areas between the pixel electrodes. As a result, a sufficient aperture ratio cannot be ensured.

### SUMMARY

An advantage of some aspects of the invention is that a liquid-crystal device, a method for driving a liquid-crystal device, a projector, and an electronic apparatus are provided such that splay-to-bend transition can be performed at high speed and a sufficient aperture ratio can be ensured.

According to an aspect of the invention, a liquid-crystal device includes first and second substrates opposing each other and a liquid-crystal layer held between the first and second substrates. The liquid-crystal device modulates light by switching the orientation of liquid-crystal molecules in the liquid-crystal layer from a splay state orientation to a bend state orientation. The liquid-crystal device further includes a pixel electrode provided for the first substrate; a first opposing electrode provided for the second substrate, an electric field capable of being generated in the liquid-crystal layer between the pixel electrode and the first opposing electrode; and a second opposing electrode provided for the second substrate, an electric field capable of being generated in the liquid-crystal layer at least between the first opposing electrode and the second opposing electrode. With this structure, an electric field that can facilitate splay-to-bend transition can be generated in the liquid-crystal layer between the first opposing electrode and the second opposing electrode formed on the opposing substrate even when no wiring lines are formed between adjacent pixel electrodes in a case where the liquid-crystal device includes a plurality of pixel electrodes. Thus, splay-to-bend transition can be performed at high speed, and a sufficient aperture ratio can be ensured. Moreover, an electric field can be generated between the pixel electrode and the second opposing electrode.

The liquid-crystal device is characterized in that the first opposing electrode can be disposed in an area including the area of the pixel electrode when viewed in plan. With this structure, a sufficiently intense electric field can be generated in the liquid-crystal layer between the first opposing electrode and the pixel electrode.

The liquid-crystal device is characterized in that the second opposing electrode is disposed in an area overlapping the peripheral area of the pixel electrode when viewed in plan. With this structure, effects on image display can be minimized. Herein, the “peripheral area” of the pixel electrode is defined as an area located outside the pixel electrode and along the outline of the pixel electrode. For example, when the liquid-crystal device includes a plurality of pixel electrodes, the peripheral area includes areas between the pixel electrodes (interpixel areas).

The liquid-crystal device is characterized in that the second opposing electrode is disposed in an area including the central part of the pixel electrode when viewed in plan. With this structure, liquid-crystal molecules in the central part of the pixel electrode, which exert a large influence on light modulation, can be reliably brought into the bend state. Thus, light-modulation performance can be improved.

The liquid-crystal device is characterized in that the first opposing electrode and the second opposing electrode are formed in the same layer. Thus, the first opposing electrode and the second opposing electrode can be formed in one step,

The liquid-crystal device is characterized in that the first opposing electrode and the second opposing electrode are formed in different layers. Thus, each of the first opposing electrode and the second opposing electrode can be formed in a desired flat area. With this, flexibility in designing the opposing electrodes can be improved. Moreover, the resistances of the first opposing electrode and the second opposing electrode can be reduced since the areas of these electrodes can be increased. Thus, unevenness in potential of the opposing electrodes can be regulated.

According to another aspect of the invention, a method for driving a liquid-crystal device, the liquid-crystal device including first and second substrates opposing each other and a liquid-crystal layer held between the first and second substrates, the liquid-crystal device modulating light by switching the orientation of liquid-crystal molecules in the liquid-crystal layer from a splay state orientation to a bend state orientation, the liquid-crystal device further including a pixel electrode provided for the first substrate; a first opposing electrode provided for the second substrate, an electric field capable of being generated in the liquid-crystal layer between the pixel electrode and the first opposing electrode; and a second opposing electrode provided for the second substrate, an electric field capable of being generated in the liquid-crystal layer at least between the first opposing electrode and the second opposing electrode, includes generating an electric field in the liquid-crystal layer between the first opposing electrode and the second opposing electrode while the orientation of the liquid-crystal molecules in the liquid-crystal layer is switched from the splay state orientation to the bend state orientation.

With this, the liquid-crystal molecules in the liquid-crystal layer of an OCB mode liquid-crystal device in an area where an electric field is generated can be brought into the bend state, and the splay-to-bend transition is propagated from the liquid-crystal molecules. As a result, the splay-to-bend transition can be performed at high speed.

According to yet another aspect of the invention, a method for driving a liquid-crystal device, the liquid-crystal device including first and second substrates opposing each other and a liquid-crystal layer held between the first and second substrates, the liquid-crystal device modulating light by switching the orientation of liquid-crystal molecules in the liquid-crystal layer from a splay state orientation to a bend state orientation, the liquid-crystal device further including a pixel electrode provided for the first substrate; a first opposing electrode provided for the second substrate, an electric field capable of being generated in the liquid-crystal layer between the pixel electrode and the first opposing electrode; and a second opposing electrode provided for the second substrate, electric fields capable of being generated in the liquid-crystal layer between the pixel electrode and the second opposing electrode and between the first opposing electrode and the second opposing electrode, includes generating an electric field in the liquid-crystal layer between the pixel electrode and the second opposing electrode while the orientation of the liquid-crystal molecules in the liquid-crystal layer is the bend state orientation.

In a so-called OCB mode liquid-crystal device, liquid-crystal molecules that are in the bend state can sometimes be switched to the splay state (reverse transition) due to effects of driving voltages or the like while the liquid-crystal device is driven. According to an aspect of the invention, the liquid-crystal device can be driven such that an electric field is generated in the liquid-crystal layer between the pixel electrode and the second opposing electrode while the liquid-crystal molecules in the liquid-crystal layer are in the bend state. Thus, the liquid-crystal molecules in the liquid-crystal layer can be securely maintained in the bend state, and thereby reverse transition can be prevented.

According to yet another aspect of the invention, a projector includes the above-described liquid-crystal device. According to an aspect of the invention, a projector having excellent display properties and high response speed can be realized using the liquid-crystal device capable of performing splay-to-bend transition at high speed and ensuring a sufficient aperture ratio.

According to yet another aspect of the invention, an electronic apparatus includes the above-described liquid-crystal device. According to an aspect of the invention, an electronic apparatus having excellent display properties and high response speed can be realized using the liquid-crystal device capable of performing splay-to-bend transition at high speed and ensuring a sufficient aperture ratio.

### BRIEF DESCRIPTION OF THE DRAWINGS

The invention will be described with reference to the accompanying drawings, wherein like numbers reference like elements.

FIG. 1 is a plan view illustrating the structure of a liquid-crystal device according to a first embodiment of the invention.

FIG. 2 is a cross-sectional view illustrating the structure of the liquid-crystal device according to the first embodiment of the invention.

FIG. 3 is a plan view illustrating a part of the liquid-crystal device according to the first embodiment of the invention.

FIGS. 4A and 4B illustrate the orientation of liquid-crystal molecules in an OCB mode liquid-crystal device.

FIG. 5 is a timing chart illustrating timing of driving the liquid-crystal device according to the first embodiment of the invention.

FIG. 6 is a timing chart illustrating timing of driving the liquid-crystal device according to the first embodiment of the invention.

FIG. 7 is a plan view illustrating a liquid-crystal device according to a second embodiment of the invention.

FIG. 8 is a cross-sectional view illustrating a liquid-crystal device according to a third embodiment of the invention.

FIG. 9 is a cross-sectional view illustrating a liquid-crystal device according to a fourth embodiment of the invention.

FIG. 10 is a cross-sectional view illustrating a liquid-crystal device according to a fifth embodiment of the invention.

FIG. 11 illustrates the structure of a projector according to a sixth embodiment of the invention.

FIG. 12 is a cross-sectional view illustrating the structure of a liquid-crystal device according to a seventh embodiment of the invention.

FIG. 13 is a perspective view illustrating the structure of a cellular phone according to an eighth embodiment of the invention.

### DESCRIPTION OF EXEMPLARY EMBODIMENTS

Embodiments of the invention will now be described with reference to the drawings. In the drawings, magnification scales of layers and components are varied as appropriate so as to facilitate the identification of the layers and the components shown in the drawings.

### First Embodiment

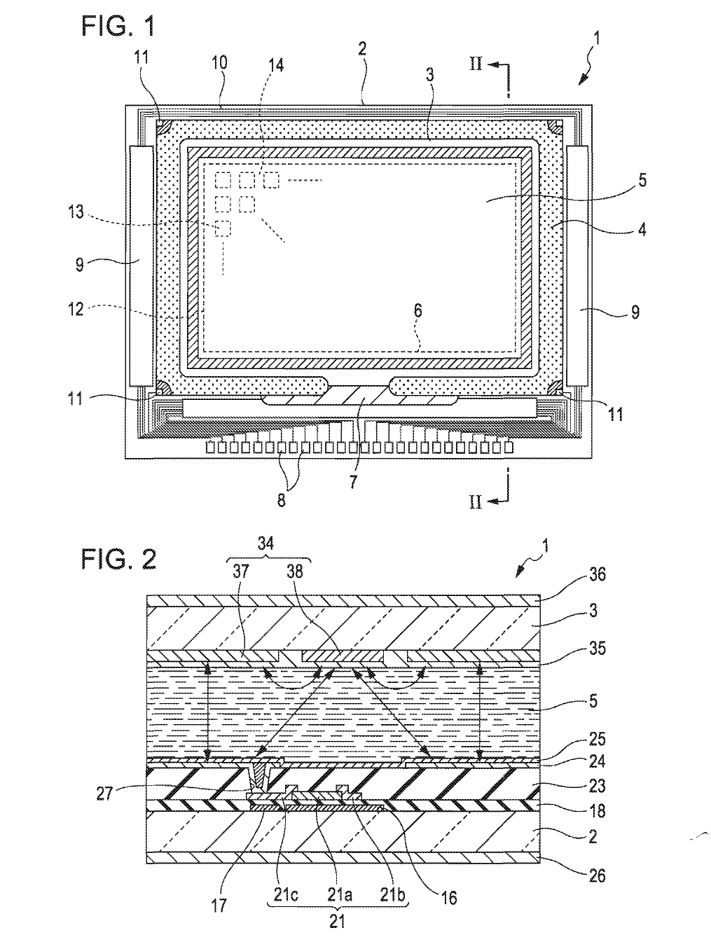

FIG. 1 is a plan view of a liquid-crystal device according to a first embodiment of the invention. In this embodiment, an active-matrix OCB mode liquid-crystal device using thin-film transistors (TFTs) as pixel switching elements will be described as an example,

As shown in FIG. 1, a liquid-crystal device 1 primarily includes a TFT array substrate 2, an opposing substrate 3, and a liquid-crystal layer 5 held between the TFT array substrate 2 and the opposing substrate 3. In this liquid-crystal device 1, the TFT array substrate 2 and the opposing substrate 3 are bonded to each other using a seal 4, and the liquid-crystal layer 5 is sealed in a space enclosed by the seal 4. The TFT array substrate 2 and the opposing substrate 3 are composed of a transparent material such as glass.

A peripheral light-shielding member 6 composed of a light-shielding material is disposed inside the seal 4. An area enclosed with the peripheral light-shielding member 6 functions as a light-modulating area 12 where external light is modulated. A matrix of sub-pixels 13 through which light can permeate is arranged inside the light-modulating area 12. Gaps between the sub-pixels 13 are interpixel areas 14 where light is blocked.

Outside the seal 4, a data-line driving circuit 7 and terminals 8 for external circuits are formed along a side of the TFT array substrate 2. Moreover, scanning-line driving circuits 9 are formed along two sides of the TFT array substrate 2 at either end of the above-described side. A plurality of wiring lines 10 for connecting the scanning-line driving circuits 9 disposed either side of the image display area are disposed along the remaining side of the TFT array substrate 2. Conductive members 11 for electrically connecting the TFT array substrate 2 and the opposing substrate 3 are disposed at the corners of the opposing substrate 3.

FIG. 2 illustrates a part of the structure of the liquid-crystal device 1 taken along line II-II in FIG. 1.

As shown in FIG. 2, the TFT array substrate 2 includes scanning lines 16, capacitor lines 17, an insulating film 18, TFTs 21, an insulating interlayer 23, pixel electrodes 24, an alignment film 25, and a polarizing sheet 26. In addition, the TFT array substrate 2 includes data lines (not shown). The scanning lines 16 and the capacitor lines 17 are formed on the inner surface (a surface facing the opposing substrate 3) of the TFT array substrate 2. The scanning lines 16 and the data lines (not shown) are formed also outside the light-modulating area 12. The scanning lines 16 and the data lines formed outside the light-modulating area 12 function as dummy lines that do not contribute to light modulation. The insulating film 18 is formed on the inner surface of the TFT array substrate 2 so as to cover the scanning lines 16 and the capacitor lines 17. The TFTs 21 are formed on the insulating film 18. Each of the TFTs 21 primarily includes a semiconductor thin film 21a, a source electrode 21b, and a drain electrode 21c. The semiconductor thin films 21a are composed of, for example, silicon, and each include a source region and a drain region. Each of the source electrodes 21b is partially formed so as to overlap with the source region of the corresponding semiconductor thin film 21a. Each of the drain electrodes 21c is partially formed so as to overlap with the drain region of the corresponding semiconductor thin film 21a. The insulating interlayer 23 is formed on the insulating film 18 so as to cover the TFTs 21.

The pixel electrodes 24 are formed on the insulating interlayer 23. The pixel electrodes 24 are composed of a transparent conductive material such as indium-tin oxide (ITO), and formed in areas corresponding to the sub-pixels 13 when viewed in plan. Contact holes 27 that pass through the insulating interlayer 23 and reach the corresponding drain electrodes 21c are partially formed in the insulating interlayer 23. The pixel electrodes 24 are electrically connected to the drain electrodes 21c via the contact holes 27. The alignment film 25 is disposed on the pixel electrodes 24. The polarizing sheet 26 is bonded to the outer surface of the TFT array substrate 2.

The opposing substrate 3 includes an opposing electrode layer 34, an alignment film 35, and a polarizing sheet 36. The opposing electrode layer 34 is formed on the inner surface (surface opposing the TFT array substrate 2) of the opposing substrate 3, and include a first opposing electrode 37 and a second opposing electrode 38. The first opposing electrode 37 is composed of a transparent conductive material such as ITO, and an electric field can be generated between the pixel electrodes 24 and the first opposing electrode 37. The second opposing electrode 38 is composed of a metal such as aluminum, chromium, and copper or a transparent conductive material such as ITO, and electric fields can be generated between the pixel electrodes 24 and the second opposing electrode 38 and between the first opposing electrode 37 and the second opposing electrode 38. The first opposing electrode 37 and the second opposing electrode 38 are formed in the same layer. The alignment film 35 is formed on the inner surface of the opposing substrate 3 so as to cover the opposing electrode layer 34. The orientation (rubbing direction) of the alignment film 35 is parallel to that of the alignment film 25 adjacent to the TFT array substrate 2. The polarizing sheet 36 is bonded to the outer surface of the opposing substrate 3.

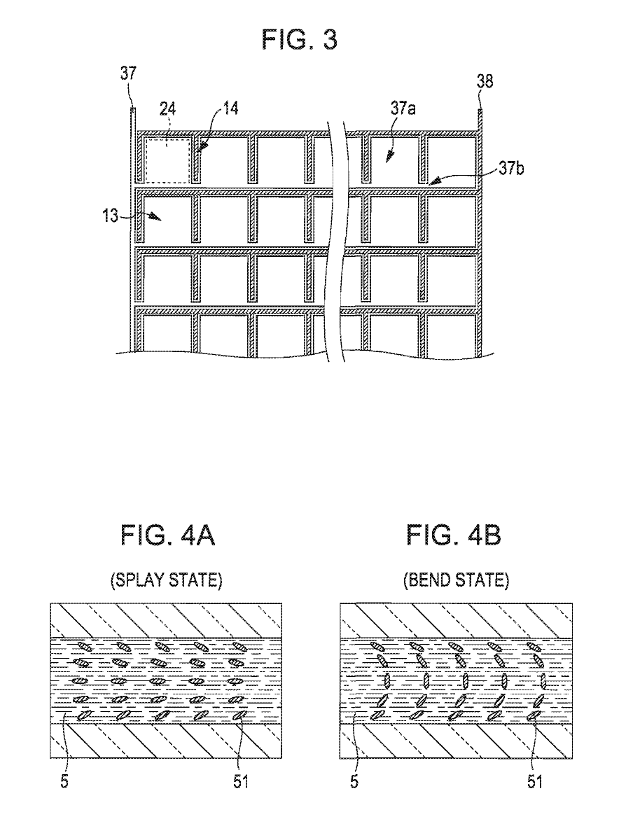

FIG. 3 is a plan view illustrating a pattern of the opposing electrode layer 34 formed on the opposing substrate 3. As shown in FIG. 3, the first opposing electrode 37 is formed in areas including the pixel electrodes 24, i.e., in areas including the sub-pixels 13 on the inner surface of the opposing substrate 3 when viewed in plan. The first opposing electrode 37 includes main portions 37a formed in the areas corresponding to the sub-pixels 13 and connecting portions 37b formed in parts of the interpixel areas 14 so as to connect the main portions 37a. With this arrangement, the first opposing electrode 37 can be entirely maintained at the same potential.

The second opposing electrode 38 is formed in peripheral areas of the pixel electrodes 24 so as to enclose the sub-pixels 13. Herein, the “peripheral areas” of the pixel electrodes 24 are defined as areas located outside the pixel electrodes 24 and along the outlines of the pixel electrodes 24. The peripheral areas of the pixel electrodes 24 include, for example, the interpixel areas 14. Herein, the second opposing electrode 38 is formed in the interpixel areas 14 serving as the peripheral areas of the pixel electrodes 24. The second opposing electrode 38 is formed in the interpixel areas 14 so as not to be brought into contact with the areas where the connecting portions 37b for connecting the main portions 37a of the first opposing electrode 37 are formed. In this manner, the second opposing electrode 38 is formed so as to be entirely maintained at the same potential.

FIGS. 4A and 4B illustrate the orientation of liquid-crystal molecules in an OCB mode liquid-crystal device. Liquid-crystal molecules 51 are in a “splay” state in which the molecules are spread apart widely as shown in FIG. 4A when the OCB mode liquid-crystal device is in an initial state (non-operating state), and the liquid-crystal molecules 51 are in a “bend” state in which the molecules are aligned so as to form bow shapes as shown in FIG. 4B when the liquid-crystal device is operating.

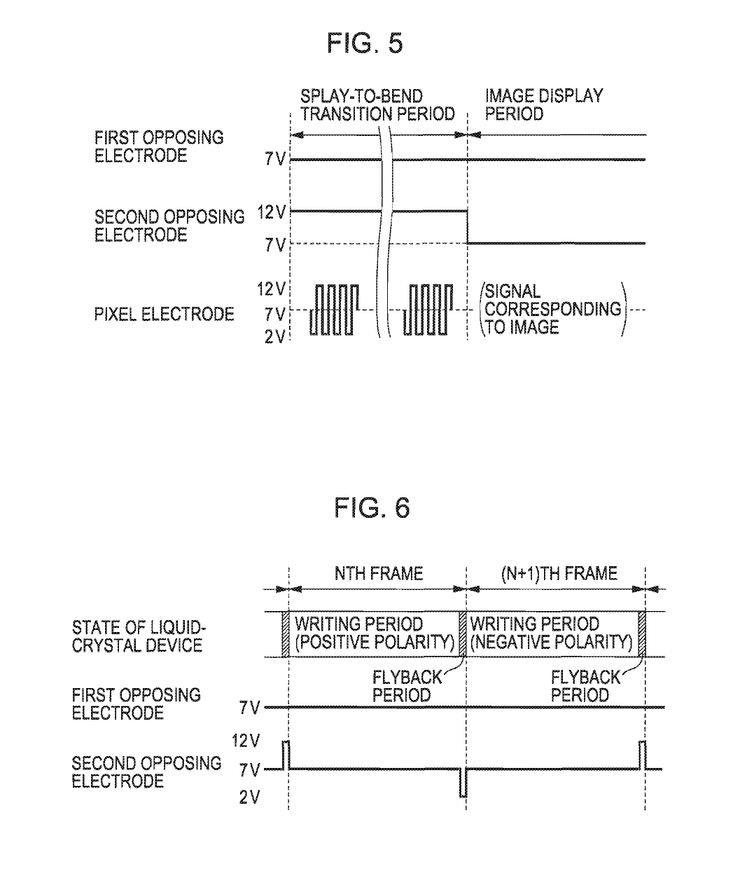

Next, a method for driving the above-described liquid-crystal device 1 will be described. FIGS. 5 and 6 are timing charts illustrating timing of driving the liquid-crystal device 1. As shown in FIG. 5, the potentials of the first opposing electrode 37 and the second opposing electrode 38 are set to 7 and 12 volts, respectively, during a splay-to-bend transition period, i.e., while the liquid-crystal device 1 is switched from the initial state to operating state. The potential of the pixel electrodes 24 oscillates between 12 volts (positive polarity) and 2 volts (negative polarity) with respect to the central voltage of 7 volts. As a result, a potential difference of 5 volts is generated between the first opposing electrode 37 and the second opposing electrode 38, and a transverse electric field is generated in the liquid-crystal layer 5. This transverse electric field causes a change in the orientation of the liquid-crystal molecules 51 in the liquid-crystal layer 5 in the uniform splay state (initial state). In addition, a potential difference of 5 volts is generated between the first opposing electrode 37 and the pixel electrodes 24, resulting in generation of an electric field. This electric field forms splay-to-bend transition nuclei in the liquid-crystal layer 5. The liquid-crystal molecules 51 in the liquid-crystal layer 5 in the areas corresponding to the sub-pixels 13 and the interpixel areas 14 when viewed in plan are brought into the bend state from the splay-to-bend transition nuclei serving as centers of arcs. When the liquid-crystal molecules 51 in the liquid-crystal layer 5 are brought into the bend state, image signals are supplied to the pixel electrodes 24 such that display operation is performed.

As shown in FIG. 6, the liquid-crystal device 1 is driven by writing pixel signals in the pixel electrodes 24. The pixel signals are supplied in each frame divided at a predetermined time. One frame corresponds to a period of one-sixtieth of a second. Each frame includes a writing period during which the pixel signals are supplied to the scanning lines 16 formed in the light-modulating area 12 and a flyback period during which the pixel signals are supplied to the dummy scanning lines 16 formed outside the light-modulating area 12. Since the dummy scanning lines 16 are formed outside the light-modulating area 12, the flyback operation is performed at the end of each frame. During the flyback period, the pixel signals are not supplied to the scanning lines 16 in the light-modulating area 12, and are not written in the pixel electrodes 24. The same applies to the data lines.

In this embodiment, a potential difference can also be generated between the first opposing electrode 37 and the second opposing electrode 38 while the liquid-crystal device 1 is operated as described above. The potential difference can be generated any time while the liquid-crystal device 1 is operated. In this embodiment, the potential difference is generated during, for example, the flyback period.

For example, the potential of the first opposing electrode 37 is set to 7 volts, and the potential of the second opposing electrode 38 is set to 2 volts (negative polarity) in the Nth frame during the flyback period. In the next (N+1)th frame, the potential of the first opposing electrode 37 is maintained at 7 volts, and the potential of the second opposing electrode 38 is set to 12 volts (positive polarity) during the flyback period. When such a potential difference is generated between the first opposing electrode 37 and the second opposing electrode 38 by reversing the polarity at the end of each frame, an intense electric field is generated between the pixel electrodes 24 and the second opposing electrode 38 in each frame. This intense electric field returns the liquid-crystal molecules 51 to the bend state in each frame.

In this embodiment, the opposing substrate 3 that opposes the TFT array substrate 2 having the pixel electrodes 24 includes the first opposing electrode 37 and the second opposing electrode 38. An electric field can be generated in the liquid-crystal layer 5 between the pixel electrodes 24 and the first opposing electrode 37, and a transverse electric field can be generated in the liquid-crystal layer 5 between the first opposing electrode 37 and the second opposing electrode 38 as described above. Therefore, a transverse electric field can be generated in the liquid-crystal layer 5 between the first opposing electrode 37 and the second opposing electrode 38 formed on the opposing substrate 3 even when no wiring lines are formed between the pixel electrodes 24. Thus, splay-to-bend transition can be performed at high speed, and a sufficient aperture ratio can be ensured.

In the so-called OCB mode liquid-crystal device as in this embodiment, the liquid-crystal molecules that are in the bend state can sometimes be switched to the splay state (reverse transition) due to effects of driving voltages or the like while the liquid-crystal device is driven. In this embodiment, the liquid-crystal device 1 is driven such that an intense electric field is generated in the liquid-crystal layer 5 between the pixel electrodes 24 and the second opposing electrode 38 while the liquid-crystal molecules 51 in the liquid-crystal layer 5 are in the bend state (during operating). Thus, the liquid-crystal molecules can be securely maintained in the bend state even when the liquid-crystal device 1 is operated, and thereby reverse transition can be prevented.

### Second Embodiment

Next, a second embodiment of the invention will be described. As in the first embodiment, magnification scales of components in the drawing are varied as appropriate so as to facilitate the identification of the components. In addition, descriptions of components identical to those in the first embodiment will be omitted. In this embodiment, the structure of an opposing electrode layer, which differs from that in the first embodiment, will be described with a particular emphasis.

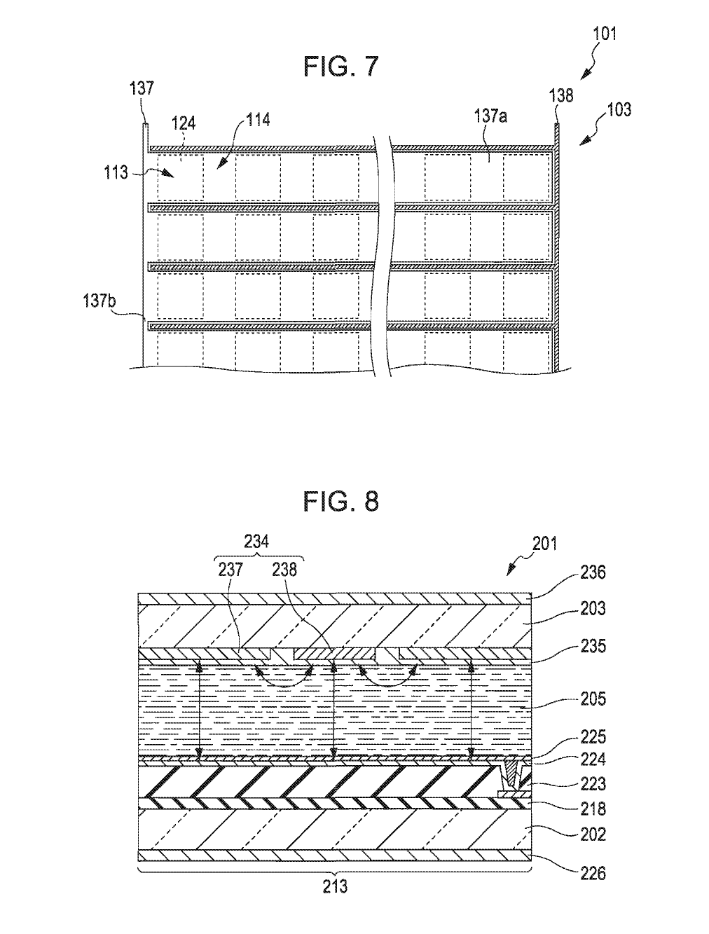

FIG. 7 is a plan view illustrating an opposing substrate of a liquid-crystal device 101 according to this embodiment. FIG. 7 corresponds to FIG. 3 in the first embodiment. As shown in FIG. 7, an opposing substrate 103 of the liquid-crystal device 101 differs from the opposing substrate 3 in the first embodiment in that a first opposing electrode 137 extends over a plurality of sub-pixels 113. More specifically, each main portion 137a of the first opposing electrode 137 covers the plurality of sub-pixels 113 arranged in a transverse direction. The main portions 137a are arranged in a longitudinal direction in a striped manner. The width of the main portions 137a (length in the longitudinal direction) is substantially equal to the length of the sub-pixels 113 in the longitudinal direction. A connecting portion 137b for connecting the main portions 137a is formed at first ends of the main portions 137a. A second opposing electrode 138 extends between adjacent main portions 137a of the first opposing electrode 137, i.e., extends over interpixel areas 114 in the transverse direction. Pixel electrodes 124 are formed on the TFT array substrate in the sub-pixels 113.

According to this embodiment, the first opposing electrode covers the plurality of sub-pixels 113 when viewed in plan as described above. With this, a sufficiently intense electric field can be generated in a liquid-crystal layer between the pixel electrodes 124 formed in the sub-pixels 113 and the first opposing electrode 137.

### Third Embodiment

Next, a third embodiment of the invention will be described. As in the first embodiment, magnification scales of components in the drawing are varied as appropriate so as to facilitate the identification of the components. In addition, descriptions of components identical to those in the first embodiment will be omitted. In this embodiment, the structure of an opposing electrode layer, which differs from that in the first embodiment, will be described with a particular emphasis.

FIG. 8 is a cross-sectional view of one of sub-pixels 213 of a liquid-crystal device 201 according to this embodiment. FIG. 8 corresponds to FIG. 2 in the first embodiment. As shown in FIG. 8, the liquid-crystal device 201 differs from the liquid-crystal device 1 in the first embodiment in that longitudinal portions of a second opposing electrode 238 of an opposing electrode layer 234 are located at central parts of pixel electrodes 224 when viewed in plan. Structures other than this are the same as in the first embodiment.

According to this embodiment, the second opposing electrode 238 is located in areas including the central parts of the pixel electrodes when viewed in plan as described above. With this, liquid-crystal molecules in the central parts of the pixel electrodes 224, which exert a large influence on light modulation, can be reliably brought into the bend state. Thus, light-modulation performance can be improved.

### Fourth Embodiment

Next, a fourth embodiment of the invention will be described. As in the first embodiment, magnification scales of components in the drawing are varied as appropriate so as to facilitate the identification of the components. In addition, descriptions of components identical to those in the first embodiment will be omitted. In this embodiment, the structure of an opposing electrode layer, which differs from that in the first embodiment, will be described with a particular emphasis.

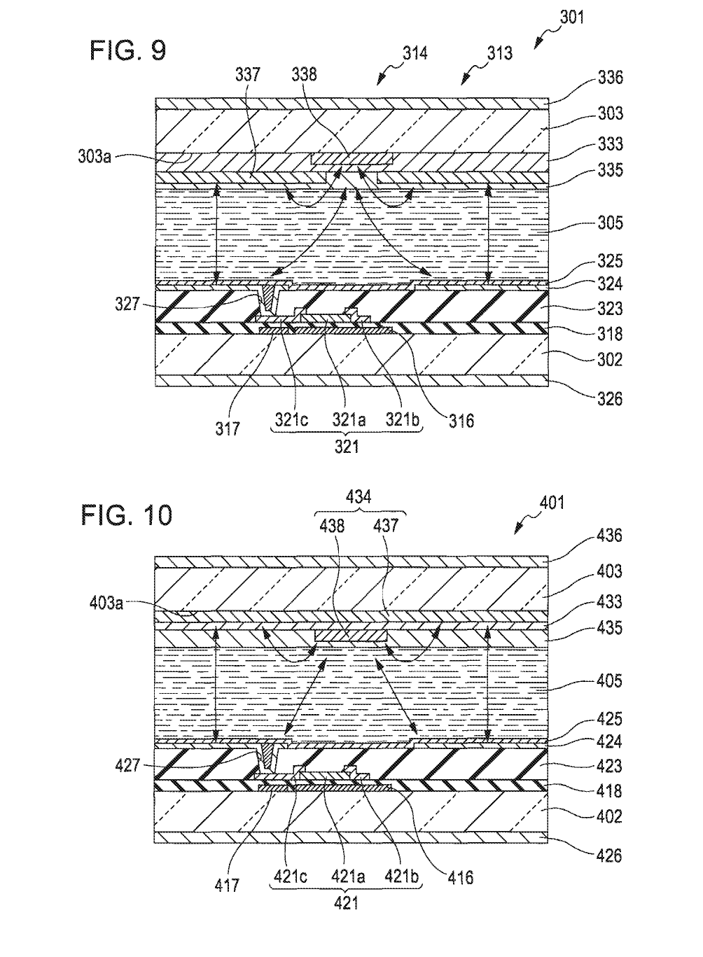

FIG. 9 is a cross-sectional view of a liquid-crystal device 301 according to this embodiment. FIG. 9 corresponds to FIG. 2 in the first embodiment. As shown in FIG. 9, the liquid-crystal device 301 differs from the liquid-crystal device 1 in the first embodiment in that a first opposing electrode 337 of an opposing electrode layer 334 is formed in an upper layer of a second opposing electrode 338. In FIG. 9, the first opposing electrode 337 is located below the second opposing electrode 338 since the upper surface 303a of an opposing substrate 303 is directed to the lower side of the drawing.

More specifically, the second opposing electrode 338 is formed on the upper surface 303a of the opposing substrate 303, and the first opposing electrode 337 is formed above the second opposing electrode 338 via an insulating layer 333. The first opposing electrode 337 is formed in sub-pixels 313 and parts of interpixel areas 314. The second opposing electrode 338 is formed in the interpixel areas 314. The first opposing electrode 337 partially overlaps with the second opposing electrode 338 when viewed in plan,

According to this embodiment, the first opposing electrode 337 is formed in the upper layer of the second opposing electrode 338, and extends to areas outside the sub-pixels 313 so as to partially overlap with the second opposing electrode 338 when viewed in plan as described above. With this, the sub-pixels 313 can be reliably covered with the first opposing electrode 337. Moreover, complicated structures such as main portions and connecting portions are not required since the first opposing electrode 337 and the second opposing electrode 338 are formed in different layers. In addition, the total resistance of the first opposing electrode 337 and the second opposing electrode 338 can be reduced since the areas of these electrodes can be increased. As a result, unevenness in potential of the first opposing electrode 337 and the second opposing electrode 338 can be regulated.

### Fifth Embodiment

Next, a fifth embodiment of the invention will be described. As in the first embodiment, magnification scales of components in the drawing are varied as appropriate so as to facilitate the identification of the components. In addition, descriptions of components identical to those in the first embodiment will be omitted. In this embodiment, the structure of an opposing electrode layer, which differs from that in the first embodiment, will be described with a particular emphasis.

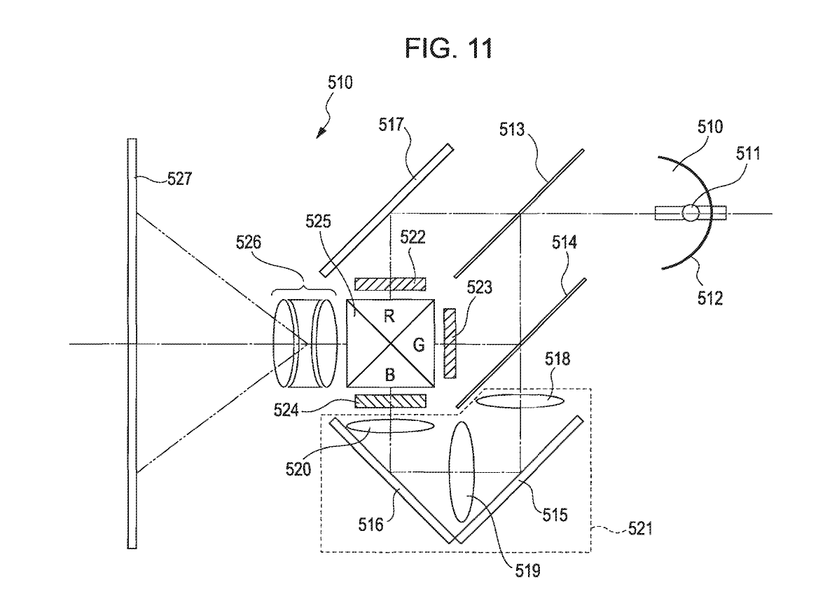

FIG. 10 is a cross-sectional view of a liquid-crystal device 401 according to this embodiment. FIG. 10 corresponds to FIG. 2 in the first embodiment. As shown in FIG. 10, the liquid-crystal device 401 differs from the liquid-crystal device 1 in the first embodiment in that a first opposing electrode 437 of an opposing electrode layer 434 is formed in a lower layer of a second opposing electrode 438. In FIG. 10, the first opposing electrode 437 is located above the second opposing electrode 438 since the upper surface 403a of an opposing substrate 403 is directed to the lower side of the drawing as in the fourth embodiment.

More specifically, the first opposing electrode 437 is formed on the upper surface 403a of the opposing substrate 403, and the second opposing electrode 438 is formed above the first opposing electrode 437 via an insulating layer 433. The first opposing electrode 437 is formed over the entire upper surface 403a of the opposing substrate 403. The second opposing electrode 438 is formed in interpixel areas 414.

According to this embodiment, the first opposing electrode 437 is formed over the entire upper surface 403a of the opposing substrate 403 as described above. With this, sub-pixels 413 can be reliably covered with the first opposing electrode 437. Moreover, complicated structures such as main portions and connecting portions are not required since the first opposing electrode 437 and the second opposing electrode 438 are formed in different layers. In addition, the total resistance of the first opposing electrode 437 and the second opposing electrode 438 can be reduced since the areas of these electrodes can be increased. As a result, unevenness in potential of the first opposing electrode 437 and the second opposing electrode 438 can be regulated.

### Sixth Embodiment

Next, the structure of a projection display apparatus (projector) including liquid-crystal devices according to the above-described embodiments as light-modulating means will be described with reference to FIG. 11. FIG. 11 illustrates a principal part of the projection display apparatus including the liquid-crystal devices according to the above-described embodiments as light-modulating units. The projection display apparatus shown in FIG. 11 includes a light source 510, dichroic mirrors 513 and 514, reflecting mirrors 515, 516, and 517, an entrance lens 518, a relay lens 519, an exit lens 520, liquid-crystal light-modulating units 522, 523, and 524, a cross-dichroic prism 525, and a projection lens 526.

The light source 510 includes a lamp 511 such as a metal halide lamp and a reflector 512 that reflects the light of the lamp. The dichroic mirror 513 reflects blue light and green light, and allows passage of red light among light beams emitted from the light source 510. The red light passing through the dichroic mirror 513 is reflected by the reflecting mirror 517, and is incident on the liquid-crystal light-modulating unit 522 for red light including the liquid-crystal device according to the above-described embodiments of the invention.

On the other hand, green light among the color beams reflected by the dichroic mirror 513 is reflected by the dichroic mirror 514, and is incident on the liquid-crystal light-modulating unit 523 for green light including the liquid-crystal device according to the above-described embodiments of the invention. Blue light also passes through the dichroic mirror 514. The blue light passes through light-guiding means 521 formed of a relay lens system including the entrance lens 518, the relay lens 519, and the exit lens 520 for compensating a difference in the optical path length of the blue light, and is incident on the liquid-crystal light-modulating unit 524 for blue light including the liquid-crystal device according to the above-described embodiments of the invention.

The three color beams modulated in the light-modulating units are incident on the cross-dichroic prism 525. This prism is formed of four rectangular prisms bonded to each other, and includes a dielectric multilayer film that reflects red light and another dielectric multilayer film that reflects blue light disposed so as to form a cross shape. The three color beams are synthesized by these dielectric multilayer films so as to form a light beam for color images. The synthesized light beam is projected onto a screen 527 using the projection lens 526 serving as a projection optical system such that enlarged images are displayed.

According to this embodiment, a projector 501 having excellent display properties and nigh response speed can be realized using the liquid-crystal devices 1 to 401 capable of performing splay-to-bend transition at high speed, ensuring a sufficient aperture ratio, and preventing reverse transition of liquid-crystal molecules during driving of the liquid-crystal devices.

### Seventh Embodiment

Next, a seventh embodiment of the invention will be described. As in the first embodiment, magnification scales of components in the drawing are varied as appropriate so as to facilitate the identification of the components. In addition, descriptions of components identical to those in the first embodiment will be omitted. In this embodiment, the structure of an opposing substrate, which differs from that in the first embodiment, will be described with a particular emphasis.

FIG. 12 is a cross-sectional view of a liquid-crystal device 601 according to this embodiment. FIG. 12 corresponds to FIG. 2 in the first embodiment. As shown in FIG. 12, the liquid-crystal device 601 differs from the liquid-crystal device 1 in the first embodiment in that the liquid-crystal device 601 is used for a display section for a display apparatus, and includes color filter layers 630 formed on an opposing substrate 603. Light-shielding portions 631 are formed between the color filter layers 630. Structures other than this, for example, the structures of the first opposing electrode and the second opposing electrode, are the same as in the first embodiment. In this manner, the invention can be applied to the liquid-crystal device 601 for display including the color filter layers 630. As a matter of course, the structures of the first opposing electrode and the second opposing electrode according to the second to fourth embodiments can be adopted in this embodiment.

### Eighth Embodiment

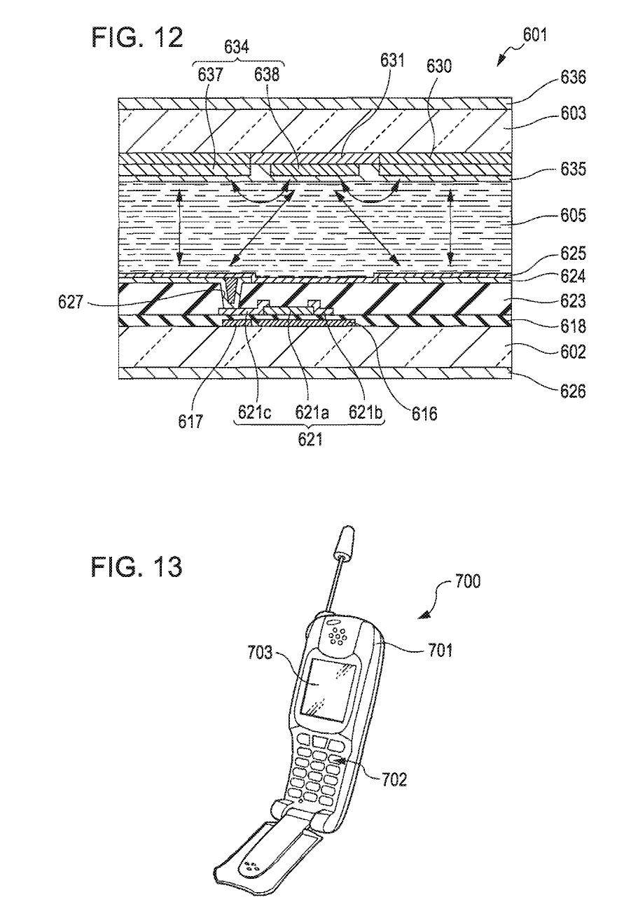

Next, an eighth embodiment of the invention will be described. In this embodiment, a cellular phone will be described as an example. FIG. 13 is a perspective view illustrating the overall structure of a cellular phone 700. The cellular phone 700 mainly includes a casing 701, an operating section 702 including a plurality of operating buttons, and a display section 703 that displays still images, moving images, text, and the like. The liquid-crystal device 601 according to the seventh embodiment is used for the display section 703.

According to this embodiment, an electronic apparatus having excellent display properties and high response speed can be realized using the liquid-crystal device 601 capable of performing splay-to-bend transition at nigh speed, ensuring a sufficient aperture ratio, and preventing reverse transition of liquid-crystal molecules during driving of the liquid-crystal devices.

The liquid-crystal devices according to the above-described embodiments can be used as image display means for electronic books, personal computers, digital still cameras, liquid-crystal televisions, video tape recorders of the view finder or direct-view type, car navigation apparatuses, pagers, electronic notepads, calculators, word processors, workstations, videophones, point-of-sale (POS) terminals, apparatuses including touch panels, and the like in addition to cellular phones. Bright and high-contrast display can be realized in any of the electronic apparatuses by using the liquid-crystal devices according to the above-described embodiments.

The technical scope of the invention is not limited to the above-described embodiments, and modifications are possible within the scope of the invention as appropriate. The second opposing electrode disposed in the interpixel areas can be composed of a metal such as aluminum and copper, and can also function as a light-shielding portion.

The entire disclosure of Japanese Patent Application No. 2006-260732, filed Sep. 26, 2006 is expressly incorporated by reference herein.

What is claimed is:

1. A liquid-crystal device, including first and second substrates opposing each other and a liquid-crystal layer held between the first and second substrates, the liquid-crystal device modulating light by switching the orientation of liquid-crystal molecules in the liquid-crystal layer from a splay state orientation to a bend state orientation, the liquid-crystal device comprising:
a pixel electrode provided for the first substrate;
a first opposing electrode provided for the second substrate, an electric field capable of being generated in the liquid-crystal layer between the pixel electrode and the first opposing electrode; and
a second opposing electrode provided for the second substrate, an electric field capable of being generated in the liquid-crystal layer at least between the first opposing electrode and the second opposing electrode.

2. The liquid-crystal device according to claim 1, wherein the first opposing electrode is disposed in an area including the area of the pixel electrode when viewed in plan.

3. The liquid-crystal device according to claim 1, wherein the second opposing electrode is disposed in an area overlapping the peripheral area of the pixel electrode when viewed in plan.

4. The liquid-crystal device according to claim 1, wherein the second opposing electrode is disposed in an area including the central part of the pixel electrode when viewed in plan.

5. The liquid-crystal device according to claim 1, wherein the first opposing electrode and the second opposing electrode are formed in the same layer.

6. The liquid-crystal device according to claim 1, wherein the first opposing electrode and the second opposing electrode are formed in different layers.

7. A method for driving a liquid-crystal device, the liquid-crystal device including first and second substrates opposing each other and a liquid-crystal layer held between the first and second substrates, the liquid-crystal device modulating light by switching the orientation of liquid-crystal molecules in the liquid-crystal layer from a splay state orientation to a bend state orientation, the liquid-crystal device further including a pixel electrode provided for the first substrate; a first opposing electrode provided for the second substrate, an electric field capable of being generated in the liquid-crystal layer between the pixel electrode and the first opposing electrode; and a second opposing electrode provided for the second substrate, an electric field capable of being generated in the liquid-crystal layer at least between the first opposing electrode and the second opposing electrode, the method comprising:
generating an electric field in the liquid-crystal layer between the first opposing electrode and the second opposing electrode while the orientation of the liquid-crystal molecules in the liquid-crystal layer is switched from the splay state orientation to the bend state orientation.

8. A method for driving a liquid-crystal device, the liquid-crystal device including first and second substrates opposing each other and a liquid-crystal layer held between the first and second substrates, the liquid-crystal device modulating light by switching the orientation of liquid-crystal molecules in the liquid-crystal layer from a splay state orientation to a bend state orientation, the liquid-crystal device further including a pixel electrode provided for the first substrate; a first opposing electrode provided for the second substrate, an electric field capable of being generated in the liquid-crystal layer between the pixel electrode and the first opposing electrode; and a second opposing electrode provided for the second substrate, electric fields capable of being generated in the liquid-crystal layer between the pixel electrode and the second opposing electrode and between the first opposing electrode and the second opposing electrode, the method comprising:
generating an electric field in the liquid-crystal layer between the pixel electrode and the second opposing electrode while the orientation of the liquid-crystal molecules in the liquid-crystal layer is the bend state orientation.

9. A projector comprising:
the liquid-crystal device according to claim 1.

10. An electronic apparatus comprising:
the liquid-crystal device according to claim 1.
